(19) United States
(12) Patent Application Publication
(10) Pub. No.: US 2018/0096634 A1
(43) Pub. Date: Apr. 5, 2018

(54) LIGHTING DEVICE AND KIT

(71) Applicants: Rebecca Gaye Walker, Birmingham, MI (US); Robert McCausland Lott, Birmingham, MI (US)

(72) Inventors: Rebecca Gaye Walker, Birmingham, MI (US); Robert McCausland Lott, Birmingham, MI (US)

(21) Appl. No.: 15/284,133

(22) Filed: Oct. 3, 2016

(51) Int. Cl. G09F 7/00; F21V 21/08; F21V 17/02; F21V 23/04; F21S 9/02; F21S 8/00; F21V 3/02

(52) U.S. Cl. CPC G09F 7/00; F21V 21/08; F21V 17/02; F21Y 2115/10; F21S 9/02; F21S 8/033; F21V 3/02; F21V 23/0471

(57) ABSTRACT

A lighting device and kit includes a power source disposed within the device. The lighting device includes a housing coupled to a light source. The lighting device includes an attachment member disposed on the housing that selectably couples and decouples the housing to and from a surface. The lighting device includes a motion sensor functionally coupled to the light source such that the light source changes to an on mode when motion is detected. The motion sensor is limited to only detecting motion that occurs at a region above the level of the motion sensor. The lighting device includes a direction indicator that is selectably adjustable between indicating various directions and coupled to the housing.

### BACKGROUND OF THE INVENTION

### Field of the Invention

The present invention relates to lighting devices, specifically a motion sensitive lighting device and a kit thereof.

### Description of the Related Art

During the night it is sometimes necessary for people to move around in the dark, but not appropriate or desired to utilize the full lighting available. This is especially important when the person is in an unfamiliar location, such as a hotel/motel and/or staying with a friend. The need to move around may be for the purpose of going to the bathroom, to do work, to get things ready for the day, etc. Further, full lighting might not be appropriate or desired for various reasons, including but not limited to: not wanting to shock the eyes, wanting to allow a companion to keep sleeping, conservation, etc.

Accordingly, in such situations, people will use various devices to navigate through a building (e.g. home, apartment, hotel room) including but not limited to flashlights, small long-burning candles (e.g. tea lights), ambient lighting from uncovered windows, etc.

One example of a lighting device that is sometimes used is a nightlight. A nightlight is a small light fixture, often electrical, placed for comfort or convenience in dark areas or areas that may become dark at certain times. Some nightlights remain lit at all times, some are turned on and off as desired and some are light sensitive such that they only turn on at night. Besides their usefulness to children in the allaying of their fears, nightlights are also useful to the general public by showing the general layout of a room without turning on a major light, for avoiding tripping over stairs or obstacles, or to mark an emergency exit. Some homeowners place nightlights in bathrooms to avoid turning on the main light fixture and causing their eyes to adjust to the light. Generally, nightlights include a plug built into the housing so that they can be plugged into a wall outlet.

Some improvements have been made in the field of lighting devices to aid in night navigation. Examples of references related to the present invention are described below in their own words, and the supporting teachings of each reference are incorporated by reference herein:

U.S. Pat. No. 6,685,332, issued to Clark, discloses a light rope runs along the stringer of a stairway and is concealed by in-fill panels fitted into a groove on a frame rail running along the wall or stringer adjacent to the stairway. A light grille having a square frame and a patterned grille insert is seated along each tread adjacent to the next higher riser and is connected to the frame rail by a pair of adjustment arms. Translucent panels are mounted on the rear of the light grilles, allowing light to shine through them. Electrical circuitry turns the lights on when a user approaches the stairs and automatically turns the lights off after a predetermined time after the user has departed the area of the stairs.

U.S. Pat. No. 8,497,634, issued to Scharf, discloses an illumination system having a first proximate detector with a first zone detector and a first transmitter. The first zone detector can detect the passing of a human body and the transmitter can send a signal upon such detection. The invention may further include a second zone detector and a second transmitter having similar capacities. In addition, the invention may also have a first staircase illuminator and a second staircase illuminator. Detection of a person passing near a zone detector may cause a staircase illuminator to illuminate a staircase area. The process of transmitting, receiving and illuminating may continue for as long as any of the illuminators within the illumination system that has not yet been illuminated. [sic]

U.S. Patent Application Publication No. 2004/0150522, by Krause, discloses a device illuminated by a light controlled by a passive infrared motion detector. The light is contained within a decorative housing shaped to appear as an article of nature or a landscaping element, such as, e.g., a rock, sea shell, brick, or branch, such that the device is not discernable as a light fixture when it is not illuminated. The device can be placed along walkways or paths, and illuminates when a person passes within the effective range of the motion detector.

U.S. Patent Application Publication No. 2004/0065813, by Goldstein, discloses a sensor causes a string of lights, for example, those sold under the trademark LIGHT ROPE™ for assisting persons to walk in a darkened room to avoid accidents. The system incorporates a motion detector (with or without time delay to keep lights ON) and a string of lights, for example, those sold under the trademark LIGHT ROPE™. The lights are laid out along a path in the home.

U.S. Patent Application Publication No. 2006/0062019, by Young, discloses a portable rechargeable night light, which comprises a replaceable luminous decorative object, a night light with an electric accumulator for emergency lighting, a base including an embedding module; a control circuit including a transformer for providing an operating power supply and a charge power supply through an electrically connected device with different voltages and setting a plurality of operating modes by a programmable control unit, and users select the setting through the module switch; a light emitting component electrically connected to and controlled by said control circuit to emitting light from a light emitting device from an end surface of the base to a luminous decorative object; and a luminous decorative object embedded on the base, of which the light emitting mode can be changed to select different operations and sensing effects of the light.

U.S. Patent Application Publication No. 2008/020458, by Dayton et al., discloses systems and methods for navigating in low light may comprise providing a light integrated in an object, associating the light with a power source, associating the light with a motion- and light-sensitive trigger, and powering the light when the motion-trigger senses motion and the light-trigger senses low light.

The inventions heretofore known suffer from a number of disadvantages which may include one or more of being non-portable, being non-customizable, being unclear as to where to proceed “forward” to a location (e.g. to groggy people who have woken up to go to the bathroom), being difficult to use, being difficult to understand when tired or otherwise compromised, only able to be installed at specific locations (e.g. wall outlets), being difficult to install, being limited in use, being limited in application, being limited to one use, being limited to being permanent installations, being limited to not being able to detach, being difficult to clean and/or service, and/or being difficult to uninstall, or other disadvantages that one of ordinary skill in the art would recognize upon reading this specification.

What is needed is a lighting device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available lighting devices and kits. Accordingly, the present invention has been developed to provide a reusable lighting device and kit that lights a pathway to a bathroom, or any other desired locations.

According to one embodiment of the invention, there is a lighting device that may include a power source that may be disposed within the device. The lighting device may include a housing that may be coupled to a light source. The lighting device may include an attachment member that may be disposed on the housing that may selectably couple and decouple the housing to and from a surface. The attachment member may consist of a layer of contact adhesive.

The lighting device includes a motion sensor that may be functionally coupled to the light source such that the light source may change to an on mode when motion is detected. The motion sensor may be limited to only detecting motion that occurs at a region above the lighting device.

The lighting device may include a direction indicator that may be selectably adjustable between indicating various directions and coupled to the housing. The direction indicator may be rotatably coupled to a front of the housing and may include a non-opaque window through which light from the light source may traverse, the window may be shaped to indicate a specific direction. The direction indicator may be selectably removable from the housing. The lighting device may also project light downwardly. The direction indicator may include a direction shape that may be selected from the group of indicator shapes consisting of: arrows, fingers, pointers, needles, hands, dials, wedges, triangles, progressively smaller shapes, progressive colors, vehicles having a front, and people.

According to one embodiment of the invention, there is a lighting kit that may include a plurality of lighting devices, that each may include a power source that may be disposed within the device. The lighting device may include a housing coupled to a light source. The lighting device may include an attachment member that may be disposed on the housing that may selectably couple and decouple the housing to and from a surface. The attachment member may consist of a layer of contact adhesive.

The lighting device may include a motion sensor that may be functionally coupled to the light source such that the light source changes to an on mode when motion is detected. The motion sensor may be limited to only detecting motion that occurs at a region above the lighting device.

The lighting device may include a direction indicator that may be selectably adjustable between indicating various directions and may be coupled to the housing. The direction indicator may be rotatably coupled to a front of the housing and may include a non-opaque window through which light from the light source may traverse, the window may be shaped to indicate a specific direction. The direction indicator may be selectably removable from the housing. The direction indicator may include a direction shape that may be selected from the group of indicator shapes consisting of: arrows, fingers, pointers, needles, hands, dials, wedges, triangles, progressively smaller shapes, progressive colors, vehicles having a front, and people.

The kit may include a pouch for storing the lighting devices of the kit. The lighting device may also project light downwardly.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a top perspective view of a lighting kit coupled to a plurality of walls of a room, according to one embodiment of the invention;

FIG. 2 is a front perspective view of a lighting device, according to one embodiment of the invention;

FIG. 3 is a bottom elevational view of a lighting device, according to one embodiment of the invention;

FIG. 4 is an exploded view of a lighting device, according to one embodiment of the invention;

FIG. 5 is a front plan view of a lighting device attached to a wall, according to one embodiment of the invention;

FIG. 6 is a perspective view of a lighting kit, according to one embodiment of the invention; and

FIG. 7 is a side cross-sectional view of a motion sensor of a lighting device, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

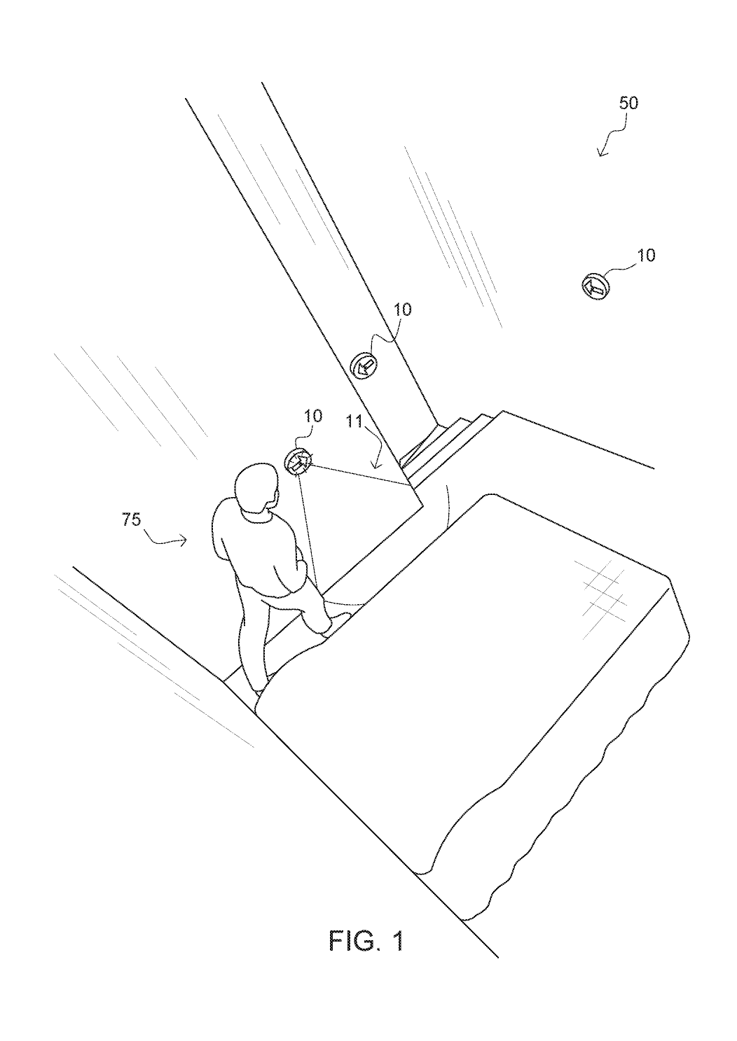

FIG. 1 is a top perspective view of a lighting kit coupled to a plurality of walls of a room, according to one embodiment of the invention. The illustrated room is similar to a layout used in some hotels. There is shown a person who may be getting out of bed to move about for some purpose (e.g. to use the restroom). There is shown a lighting kit 50 including a plurality of lighting devices 10 coupled to a plurality of surfaces (walls) of a room to direct a user 75 in a certain direction (e.g. to a bathroom) in the dark.

In the illustrated view, the lighting device 10 nearest to the person 75 is lit such that the indicator (i.e. the illustrated arrow) shines and the area beneath the lighting device is illuminated 11. The other two illustrated lighting devices are not lit, but include motion detectors such that when the person 75 approaches closer to each, they are then triggered to similarly light up. Accordingly, the way to the desired location is illuminated as the person 75 travels along the indicated directions. It may be that the person often travels on business and stays in various hotels/homes where the layout changes from place to place and it is convenient to use the kit to create a desired path before retiring for bed. Accordingly, the user has no need, on waking, to remember the layout of the room and where the restroom is. The user merely needs to get out of bed and the path will be illuminated with clear travel instructions (i.e. direction indicators) as the user moves about. Not shown may be a fourth lighting device with a different indicator (e.g. a person standing) to indicate the final destination (e.g. the bathroom door) so that the person will know when they have arrived.

The illustrated lighting kit 50 includes a plurality of lighting devices 10 coupled to a surface of a room to direct a user 75 in a direction towards a bathroom. The illustrated lighting devices 10 include motion detection sensor(s) that may have an automatic shutoff after a period of time or after a period of time when motion is no longer detected. The lighting device 10 includes an arrow (i.e. indicator) that lights up and points the user 75 in a certain direction. The arrow may be turned to point in any direction (360 degree rotation). The lighting device 10 also includes a light source that shines light downward 11 so that the area around the lighting device 10 is lit (e.g. walking area). The lighting device 10 is battery operated and includes a contact adhesive to allow the user 75 to attach the device to a wall or a piece of furniture but also be able to remove the lighting device 10 without leaving residue or damaging the wall or piece of furniture.

According to one embodiment of the invention, there is a kit 50 including a plurality of lighting device 10 that allows a user to place them in various parts of a house/hotel so that the user may light a pathway to places that the user would like to go, even around corners in the dark. The kit may include multiple lighting devices, structures/devices for affixing to surfaces, replacement parts, containers, instructions, various types/styles of indicators, and the like and combinations thereof.

According to one embodiment of the invention, there is a lighting kit 50 including a plurality of lighting devices 10, that each includes a power source disposed within the device. The lighting device includes a housing coupled to a light source. The lighting device 10 includes an attachment member disposed on the housing that selectably couples and decouples the housing to and from a surface. The lighting device 10 includes a motion sensor functionally coupled to the light source such that the light source changes to an on mode when motion is detected. The lighting device 10 includes a direction indicator that is selectably adjustable between indicating various directions and is coupled to the housing. The direction indicator is rotatably coupled to a front of the housing and includes a non-opaque window through which light from the light source may traverse; the window is shaped to indicate a specific direction and/or other useful information (e.g. location information). The lighting device 10 also project light downwardly 11 such that a floor region about the device may be illuminated.

In operation, a user having a kit with lighting devices as described herein will remove the devices from a container (e.g. bag, box, luggage) and then will place/affix the devices on surfaces in a path, each one leading to the next, that leads from one place in a building to another place (e.g. bed to bathroom). The devices will be placed on the surface in a manner/orientation that permits the light from the side of the device to shine on a desired area in a desired manner. The devices may be placed at heights and/or manipulated in manners to adjust how sensitive, or in which locations, the motion detection sensor(s) will detect motion (e.g. placed low enough to the ground near the bed that motion of the bed and/or of draping legs/etc. do not trigger illumination. The user will adjust the indicators (e.g. rotate the front face with the arrow) until it is pointing/indicating an appropriate direction of travel to the next device and/or the final destination. Advantageously, when the user is ready to move about in the building in the dark from the “one place” to the “next” that user will be able to do so with illumination and directions to make such much easier, convenient, and more safe.

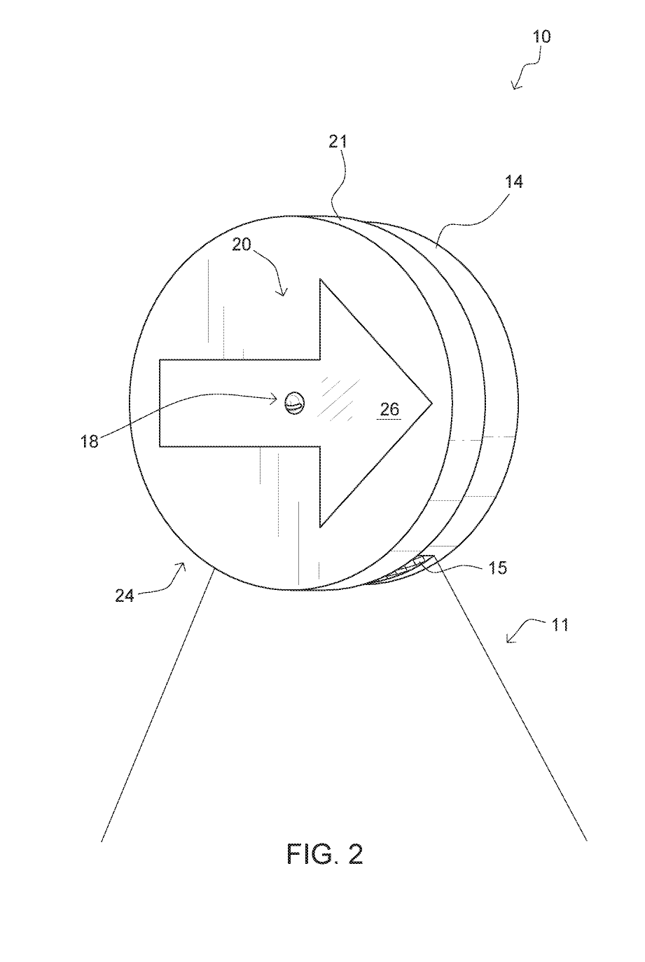

FIG. 2 is a front perspective view of a lighting device, according to one embodiment of the invention. There is shown a lighting device 10 including a housing 14 with a light aperture 26 and a front face 21 having a direction indicator 20 functionally coupled to the housing 14 such that the front face may be rotated by the user as desired. The lighting device may be affixed to a surface, such as but not limited to a wall, window, door, or side of furniture, then oriented to point in a desired direction and then turned on to operate for the benefit of the user. The illustrated lighting device 10 is designed to light up an area 11 around the lighting device 10 and provide a lighted direction indicator to direct a user to a desired location, when a motion sensor 18 is activated.

The illustrated lighting device 10 includes a housing 14 coupled to and/or enclosing a light source and a power source. The light source may of various types, including but not limited to LED lights, incandescent/fluorescent/halogen/tungsten bulbs, and/or luminous materials that are able to be covered by associated devices. The power source may include, but it not limited to: batteries, capacitors, remote wireless power systems, mechanical-electric power generation devices, outlet plugs and the like. The light source(s) and the motion detection sensor(s) are functionally coupled to the power source such that they may be powered for operation. There may be one or more devices that change access to power or otherwise turn the device on/off, such as but not limited to switches (e.g. toggle, pushbutton, selector, joystick, pressure, orientation), logical control circuits, timers and the like and combinations thereof. Such may be used to prevent power loss during travel and storage but permit operation of the device(s) when installed in a location.

The illustrated lighting device 10 includes a front face 21 having a direction indicator 20 that is selectably adjustable between indicating various directions and is coupled to the housing 14. The illustrated front face 21 is rotatably coupled to the housing 14 and does not extend so that it blocks the window The direction indicator 20 is rotatably coupled to a front 24 of the housing 14 and includes a non-opaque window 26 (light aperture) through which light from the light source traverses, the window 26 is shaped to indicate a specific direction. The non-opaque window may be transparent, translucent, devoid of materials and/or combinations thereof. The direction indicator 20 is selectably removable from the housing 14. The illustrated lighting device 10 also projects light 11 downwardly through the non-opaque window through the housing. The direction indicator 20 may include a direction shape that may be selected from the group of indicator shapes consisting of: arrows, fingers, pointers, needles, hands, dials, wedges, triangles, progressively smaller shapes, progressive colors, vehicles having a front, and people.

The illustrated lighting device 10 includes a motion sensor 18 that is functionally coupled to the light source such that the light source changes to an on mode when motion is detected. The illustrated motion sensor 18 is disposed centrally through the front face so that the face may rotate without changing location or operation of the motion sensor. The illustrated front face includes an aperture through which the motion sensor extends.

The illustrated motion sensor 18 is limited to only detecting motion that occurs at a region above the lighting device 10 because of the location of the motion sensor 18 and/or by operation of how the motion sensor 18 is oriented/configured to thus block reception of signals accessible to the motion detection device that occur below the bottom of the device 10. Accordingly, one may establish the sensitivity region of the motion detection by the height and location where the device 10 is placed on a surface.

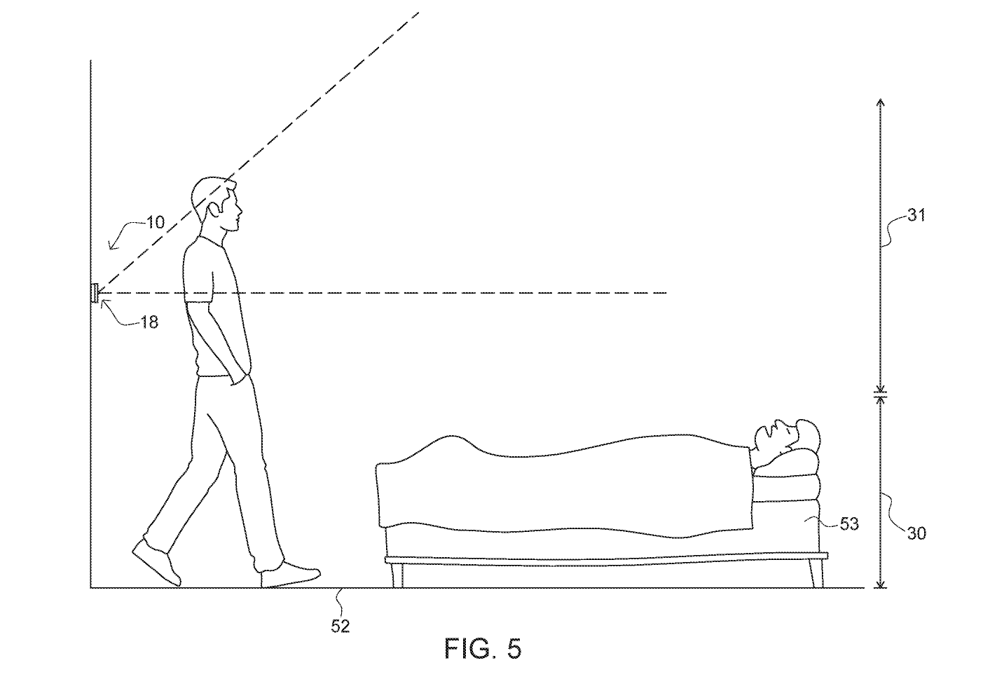

As an example, when sleeping on a bed one is likely to want the device to remain unlit until a person stands up (See FIG. 5) but not be lit by turning over on the bed, a small pet walking by, or the person draping a foot over the edge. Accordingly, the user would place the first device a few inches off the floor, or at waist level, or at chest level, where the user expects to be when getting out of bed. The remaining devices may be placed higher/lower on a wall/surface as desired so that they detect the user as the user approaches. Accordingly, normal sleeping behaviors will not cause the devices to light, but normal room travel will.

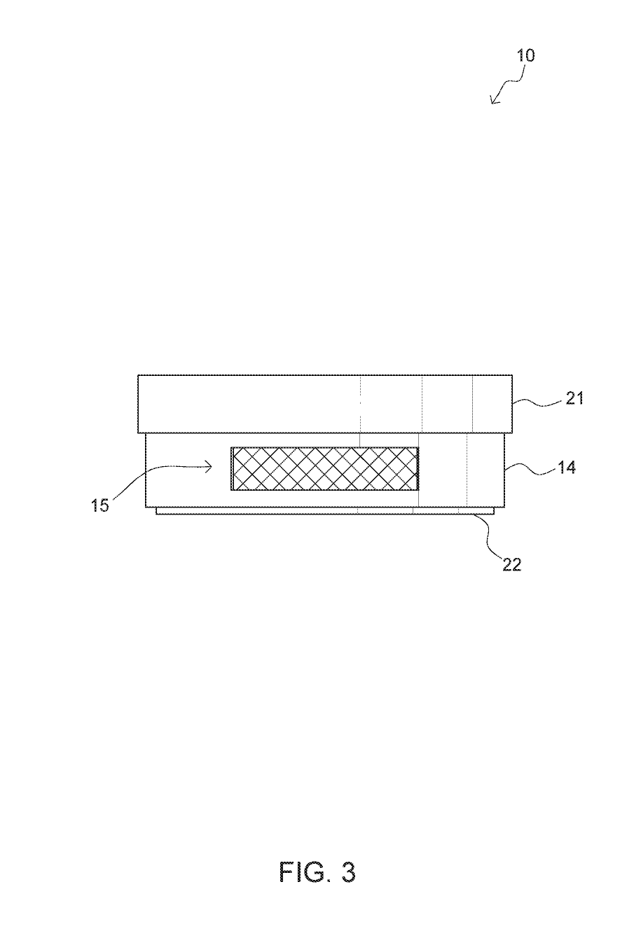

FIG. 3 is a bottom elevational view of a lighting device, according to one embodiment of the invention. There is shown a lighting device 10 including a housing 14 coupled to each of a front face 21 and an attachment member 22. The housing includes, at the bottom thereof, a non-opaque window 15.

The illustrated lighting device 10 is designed to light up an area around the lighting device 10 and provide a lighted direction indicator to direct a user to a desired location, when a motion sensor is activated. The lighting device 10 includes a housing 14 coupled to a light source and a power source. The lighting device 10 includes an attachment member 22 disposed on the housing 14 that selectably couples and decouples the housing 14 to and from a surface. The illustrated lighting device 10 also projects light downwardly; wherein the housing 14 includes a bottom non-opaque window 15 to allow light from the light source to not only traverse light through a direction indicator disposed about a front of the housing, but also through the bottom non-opaque window 15.

The illustrated lighting device 10 includes an attachment member 22 disposed on the housing 14 that selectably couples and decouples the housing 14 to and from a surface. Such may be embodied as one or more layers of adhesive material (e.g. glue, contact adhesives, “gecko tape” (i.e. arrays of nanoscale projections on a plane that take advantage of capillary and Van Der Walls forces to create adhesion), poster gum, adhesives with pull-tabs removal structures, double-sided adhesive sheets, and the like and combinations thereof. Also or alternatively, coupling devices such as hook-and-loop, snaps, clips, wall stakes, hooks, screws, magnets, suction cups, and the like may be disposed on the housing to allow the same to couple to surface(s). The attachment member and/or components thereof may be detachable from the housing, such as but not limited to in an example wherein a housing includes a plurality of stacked layers of contact adhesive that allow the user to detach a layer once it is no longer tacky to then reveal a fresh layer of contact adhesive therebehind to be used. A kit may include one or more such stacks of contact adhesive layers.

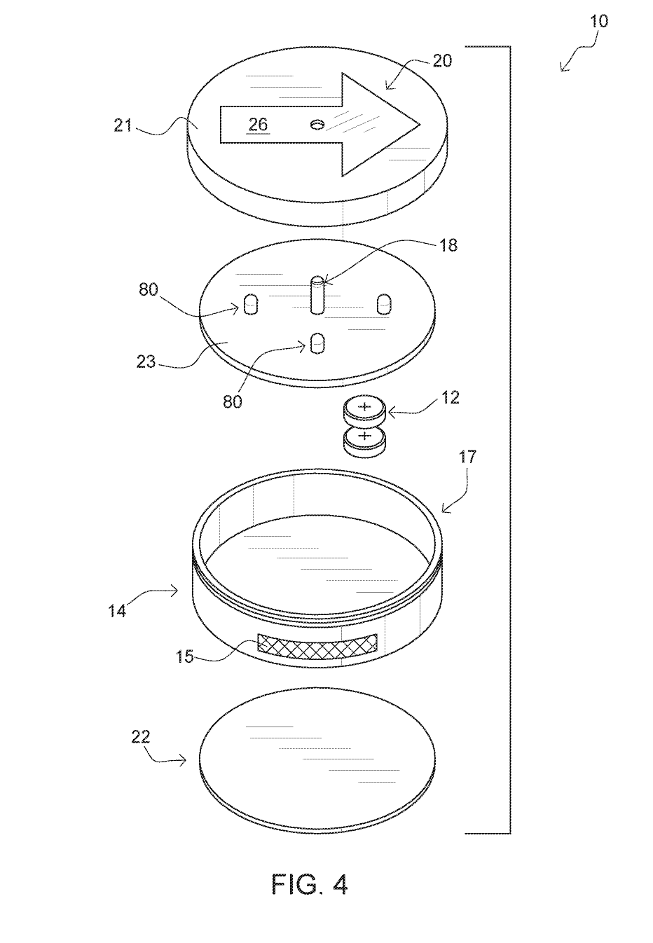

FIG. 4 is an exploded view of a lighting device, according to one embodiment of the invention. There is shown a lighting device 10 including a front face 21 and a housing 14, that together enclose a power source 12 functionally coupled to each of a light source 80, and a motion detection sensor 18. There is an attachment member, which is illustrated as a piece of contact adhesive 22, coupled to a rear of the housing 14.

The illustrated housing 14 is a dish-shaped structure with a coupling structure 17 on the outer lip thereof. Other coupling structures may be used to rotatably couple the housing to the front face, such as but not limited to bearing tracks with bearings, friction fittings, notched fittings, mating hooked lips and the like and combinations thereof. The housing includes a window 15 disposed on a bottom region thereof. The housing includes space into which a wafer 23 may be disposed, the wafer including circuitry as required for operation of the device and fixing the locations of the lights thereon.

The illustrated front face 21 is a dish-shaped structure similar to the illustrated housing 14 but having an inner circumference that is about the same as the outer circumference of the housing such that the two can mate together and thereby enclose the contents thereof. The mating of the two is through a coupling structure 17. The illustrated coupling structure is a track of grooves that may match with a similar track of grooves on an inner lip of the front face, such that the two tracks of grooves mate and allow for the front face and housing to be rotatably coupled together. The fitting may allow for a frictional resistance to rotation (e.g. the two sets of grooves form a fairly tight fit that is not lubricated), such that once the orientation of the front face is set, it will remain so unless manually adjusted. The front face 21 includes a direction indicator 20, which is illustrated as an arrow 26. The arrow is a non-opaque window that may be of translucent and/or transparent material (e.g. glass, plastic, clear mineral) and/or devoid of material, such that light from inside the device may emanate therefrom. The arrow may be of a colored material so that when the light so emanates it is of a particular color. The color may be red or a shade thereof, since red is known to interfere with human vision in darkness the least.

The illustrated lighting device 10 includes a power source 12 disposed within the device 10. The illustrated power source is a button-cell battery (e.g. watch battery), but could be any of various types of batteries including but not limited to cylindrical cell batteries (e.g. AA, AAA, C, D) and/or non-cylindrical batteries (e.g. 9-volt). There may be multiple power sources disposed within the device, including but not limited to solar cells, mechanical power generators, outlet plugs and the like. Batteries may be rechargeable.

The lighting device 10 includes a housing 14 coupled to a light source 80. The illustrated light source is a triplet of miniature LED lights placed on a wafer 23 (through which they are coupled to the power source) in locations configured to efficiently transmit light through the arrow 26 and through the downward facing window 15. LED lights are advantageous because of their small size, weight, and low power consumption for the amount of light produced.

The lighting device 10 includes an attachment member disposed on the housing 14 that selectably couples and decouples the housing 14 to and from a surface. The illustrated attachment member consists of a layer of contact adhesive 22.

The illustrated lighting device 10 includes a motion sensor 18 disposed on the wafer 23 and thereby functionally coupled to the light source 80 and the power source 12 such that the light source 80 changes to an on mode when motion is detected. The motion sensor 18 is limited to only detecting motion that occurs at a region above the lighting device 10. Motion sensors may be of various types, including but not limited to passive infrared, microwave, ultrasonic, tomographic, and/or video camera. There may be shielding (e.g. present within the housing material/body, present as a cover over part of the sensor) that prevents the motion sensor from detecting motion below a predefined level. Such shielding may be sheet metal, metallic foil or metallic mesh/foam or other material of the appropriate size for the wavelength of light/sound that prevents the transmission of the waves (e.g. microwaves, IR, radio waves, visible light, IR light) therethrough. There may be multiple motion sensors and such may be of various types in order to reduce/prevent false signals from causing the device to light by mistake.

The illustrated lighting device 10 includes a direction indicator 20 that is selectably adjustable between indicating various directions and is coupled to the housing 14. The direction indicator 20 is rotatably coupled to a front of the housing 14 and includes a non-opaque window 26 through which light from the light source 80 traverses, the window 26 is be shaped to indicate a specific direction. The direction indicator 20 is selectably removable from the housing 14. The lighting device 10 also projects light downwardly through a bottom non-opaque window 15. The direction indicator 20 includes a direction shape that is selected from the group of indicator shapes consisting of: arrows, fingers, pointers, needles, hands, dials, wedges, triangles, progressively smaller shapes, progressive colors, vehicles having a front, and people.

FIG. 5 is a front plan view of a lighting device attached to a wall near a bed, according to one embodiment of the invention. There is shown a lighting device 10 near a bed 53 including a motion sensor 18 to detect motion at a region 31 above the lighting device 10 but not the region below 30. A user's foot may dangle below the top of the bed but not trigger the motion sensor 18 of the device. The motion sensor 18 does not sense motion below the sensor's sensing levels such as when the person turns over in bed, when blankets move along the side of the bed, etc. However, should a person stand up and their body be within the upper region 31, the device will trigger and illumination will commence.

The limitation on the motion sensor 18 may be a result of shielding of the sensor so that it is not sensitive in certain regions 30 but sensitive in other regions 31. It may be that the line between such regions is not parallel with the ground, but at an angle. Such definitions of where the motion is detected and not will depend on the precise arrangement of any shielding and such may vary from device to device in a kit. As an example, a device intended to be placed near a bed may have heavy shielding, while a device intended to be placed on a door to a bathroom may have no shielding at all so that it has a full range of detection and illuminates as soon as a user is “in view” of the device.

The illustrated lighting device 10 is designed to light up an area below the lighting device 10 and provide a lighted direction indicator to direct a user to a desired location, when a motion sensor 18 is activated. The lighting device 10 includes a housing coupled to a light source and a power source. The lighting device 10 includes an attachment member disposed on the housing that selectably couples and decouples the housing to and from a surface.

The illustrated lighting device 10 includes a motion sensor 18 functionally coupled to the light source such that the light source changes to an on mode when motion is detected. The motion sensor 18 is limited to only detecting motion that occurs at a region 31 above the level of the motion sensor 18.

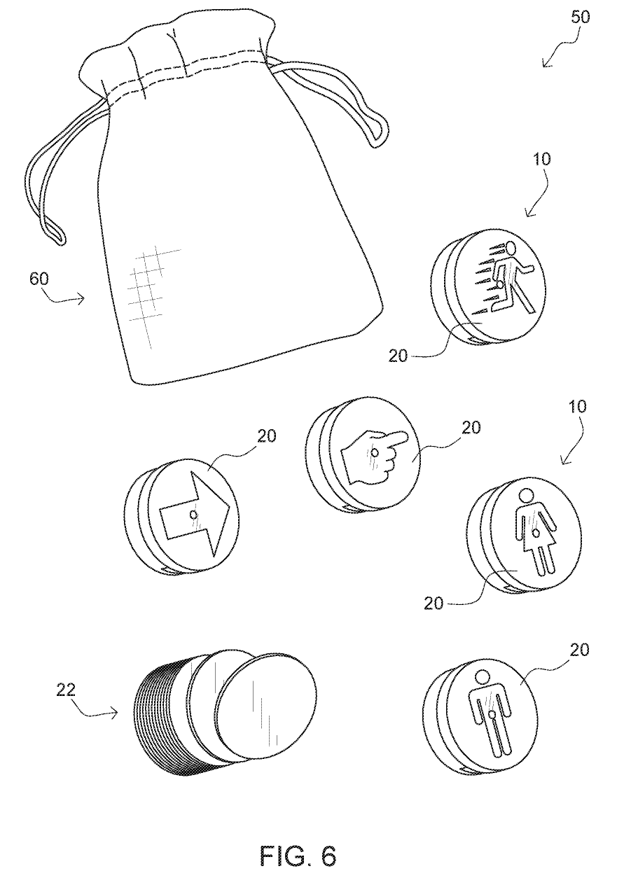

FIG. 6 is a perspective view of a lighting kit, according to one embodiment of the invention. There is shown a lighting kit 50 including a plurality of lighting devices 10 having various direction/location indicators 20, a plurality of attachment members, such as contact adhesives 22, and a pouch 60 to contain the other components of the kit. The illustrated lighting kit 50 is designed to light up portions of a building interior with a plurality of lighting devices 10 designed to light up an area below the lighting device 10 and provide a lighted direction indicator to direct a user to a desired location, when a motion sensor is activated. Each lighting device 10 includes a power source disposed within the device. The lighting devices 10 each include a housing coupled to a light source. The lighting kit 50 includes a plurality of attachment members, as illustrated in FIG. 6 as contact adhesives 22, designed to be disposed on the housing that selectably couples and decouples the housing to and from a surface. The illustrated attachment members include a plurality of layers of contact adhesive 22 (e.g. thin plastic sheets with contact adhesive on one side of each, except for the last sheet which includes contact adhesive on both sides).

Each lighting device 10 includes a motion sensor functionally coupled to the light source such that the light source changes to an on mode when motion is detected. The motion sensor is limited to only detecting motion that occurs at a region above the level of the motion sensor of each lighting device 10.

The lighting kit 50 includes a plurality of direction indicators 20 that are selectably adjustable between indicating various directions and is coupled to the housing. The direction indicator 20 may be rotatably coupled to a front of the housing and includes a non-opaque window through which light from the light source traverses, the window is shaped to indicate a specific direction. The direction indicator 20 is selectably removable from the housing. The direction indicator 20 includes a direction shape that is selected from the group of indicator shapes consisting of: arrows, fingers, pointers, needles, hands, dials, wedges, triangles, progressively smaller shapes, progressive colors, vehicles having a front, and people. The illustrated lighting kit 50 includes a pouch 60 for storing the lighting devices 10 of the kit 50. A kit may include a greater number of front face units than the number of housing units with wafers disposed inside; such that the user can mix-match front faces as desired to couple together with the functioning housings.

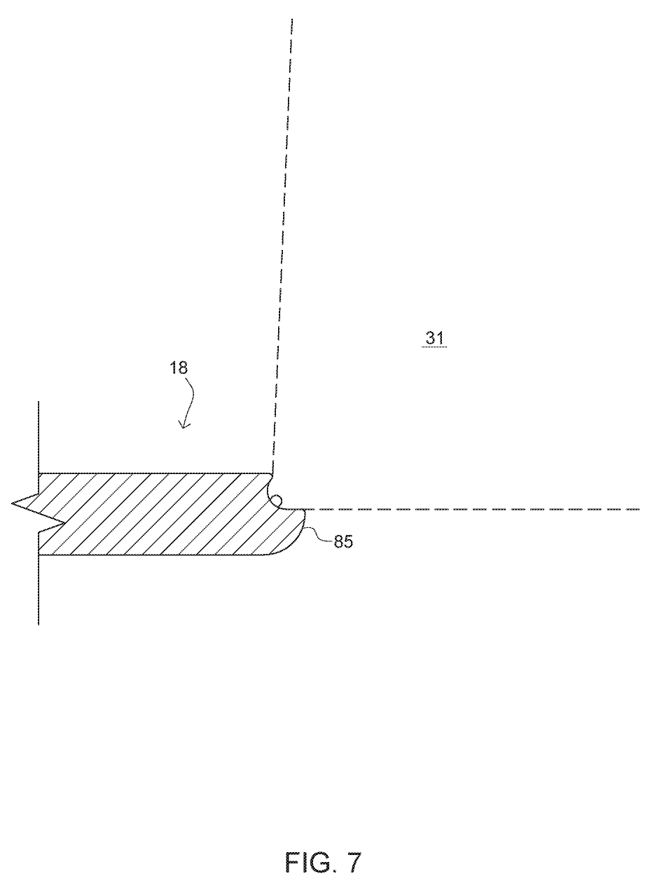

FIG. 7 is a side cross-sectional view of a motion sensor of a lighting device, according to one embodiment of the invention. There is shown a motion sensor 18 of a lighting device, including a focal point of the motion sensor 18 to direct the motion sensor to sense in a particular region 31 above the level of the motion sensor 18.

The illustrated motion sensor 18 is functionally coupled a light source such that the light source changes to an on mode when motion is detected. The motion sensor 18 is limited to only detecting motion that occurs at a region 31 above the motion sensor 18 of the lighting device. The motion sensor 18 includes a shield 85 that prevents the motion sensor from detecting motion below a predefined level. Such shielding may be sheet metal, metallic foil or metallic mesh/foam or other material of the appropriate size for the wavelength of light/sound that prevents the transmission of the waves therethrough. The illustrated shield 85 directs the motion sensor sensitivity to a particular region 31.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

It is expected that there could be numerous variations of the design of this invention. An example is that the housing and/or the front face need not be cylindrical as illustrated but may be of any shape, so long as they are able to rotate with respect to one another.

For example, instead of a bottom-facing window, the housing may include an external light source that projects light outward/downward. Also, the housing might be open on the back thereof instead of having a solid back (e.g. may be ring-shaped) and the wafer may be accessible therethrough. In such a housing, the attachment member may be ring-shaped as well. There may be a removable adhesive plate on the backside of the housing. There may be a selectably openable port on the backside of the housing and/or one on the front-side of the front face such that the inside may be accessible therethrough.

Further, the device may include one or more lights that are always on when the device is turned on and such may function as a nightlight and/or as a point indicator as to where the device is placed. Such a light may be a fluorescent material that is otherwise unpowered but still produces light.

Additionally, any of the windows/apertures described herein may have covers that may be selectably placed thereover. Also, the front face may be lockably coupled to the housing such that once oriented as desired that particular orientation may be locked into place, wherein a tab, button, pin, or other structure may prevent further rotation between the housing and the front face.

Finally, it is envisioned that the components of the device may be constructed of a variety of materials, including but not limited to plastics, rubbers, metals, ceramics, natural fibers, wood, composites and the like and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

1. A lighting device, comprising:
a) a power source disposed within the device;
b) a housing coupled to the light source;
c) an attachment member disposed on the housing that selectably couples and decouples the housing to and from a surface;
d) a motion sensor functionally coupled to the light source such that the light source changes to an on mode when motion is detected; and
e) a direction indicator that is selectably adjustable between indicating various directions and coupled to the housing.

2. The device of claim 1, wherein the attachment member consists of a layer of contact adhesive.

3. The device of claim 1, wherein the direction indicator is rotatably coupled to a front of the housing and includes a non-opaque window through which light from the light source may traverse, the window being shaped to indicate a specific direction.

4. The device of claim 1, wherein the motion sensor is limited to only detect motion that occurs at a region below the lighting device.

5. The device of claim 1, wherein the direction indicator is selectably removable from the housing.

6. The device of claim 1, wherein the lighting device also projects light downwardly.

7. The device of claim 1, wherein the direction indicator includes a direction shape selected from the group of indicator shapes consisting of: arrows, fingers, pointers, needles, hands, dials, wedges, triangles, progressively smaller shapes, progressive colors, vehicles having a front, and people.

8. A lighting device, comprising:
a) a power source disposed within the device;
b) a housing coupled to the light source;
c) an attachment member disposed on the housing that selectably couples and decouples the housing to and from a surface; wherein the attachment member consists of a layer of contact adhesive;
d) a motion sensor functionally coupled to the light source such that the light source changes to an on mode when motion is detected; and
e) a direction indicator that is selectably adjustable between indicating various directions and coupled to the housing.

9. The device of claim 8, wherein the direction indicator is rotatably coupled to a front of the housing and includes a non-opaque window through which light from the light source may traverse, the window being shaped to indicate a specific direction.

10. The device of claim 9, wherein the motion sensor is limited to only detect motion that occurs at a region below the lighting device.

11. The device of claim 10, wherein the direction indicator is selectably removable from the housing.

12. The device of claim 11, wherein the lighting device also projects light downwardly.

13. The device of claim 12, wherein the direction indicator includes a direction shape selected from the group of indicator shapes consisting of: arrows, fingers, pointers, needles, hands, dials, wedges, triangles, progressively smaller shapes, progressive colors, vehicles having a front, and people.

14. A lighting kit, comprising:
a) plurality of lighting devices, each including:
a1) a power source disposed within the device;
a2) a housing coupled to the light source;
a3) an attachment member disposed on the housing that selectably couples and decouples the housing to and from a surface;
a4) a motion sensor functionally coupled to the light source such that the light source changes to an on mode when motion is detected; and
a5) a direction indicator that is selectably adjustable between indicating various directions and coupled to the housing; and
b) a pouch for storing the lighting devices of the kit.

15. The kit of claim 14, wherein the attachment member consists of a layer of contact adhesive.

16. The kit of claim 14, wherein the direction indicator is rotatably coupled to a front of the housing and includes a non-opaque window through which light from the light source may traverse, the window being shaped to indicate a specific direction.

17. The kit of claim 14, wherein the motion sensor is limited to only detect motion that occurs at a region below the lighting device.

18. The kit of claim 14, wherein the direction indicator is selectably removable from the housing.

19. The kit of claim 14, wherein the lighting device also projects light downwardly.

20. The kit of claim 14, wherein the direction indicator includes a direction shape selected from the group of indicator shapes consisting of: arrows, fingers, pointers, needles, hands, dials, wedges, triangles, progressively smaller shapes, progressive colors, vehicles having a front, and people.
